(19) United States
(12) Patent Application Publication
(10) Pub. No.: US 2012/0237190 A1
(43) Pub. Date: Sep. 20, 2012

(54) WATER DISPENSER CONTROL CIRCUIT AND CONTROL METHOD THEREOF

(75) Inventor: HUI LI, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/149,949

(22) Filed: Jun. 1, 2011

(30) Foreign Application Priority Data
Mar. 18, 2011 (CN) 201110065873.7

(51) Int. Cl. F24H 1/20; B67D 1/00

(52) U.S. Cl. 392/451; 222/52

(57) ABSTRACT

A water dispenser control circuit includes a detection circuit, a heating circuit, a water temperature sensing circuit, and a power circuit. The detection circuit is configured for detecting whether or not a user comes into a detection area. The heating circuit is configured for heating the water. The water temperature sensing circuit is configured for sensing the temperature of the water. The power circuit supplies power to the detection circuit, the heating circuit, and the water temperature sensing circuit. When the user comes into the detection area, the detection circuit controls the heating circuit to heat the water as the water temperature sensing circuit senses the temperature of the water greater than a preset temperature.

### BACKGROUND

1. Technical Field

The present disclosure relates to water dispensers, and particularly, to a water dispenser control circuit and a control method thereof.

2. Description of Related Art

Water dispensers may include a heating system and an infrared detector. The heating system is used to heat the water in the water dispensers. The infrared detector detects whether or not a user comes into a detection area. When the user comes into the detection area, the heating system starts to heat the water. The heating system stops heating the water, when the user leaves the detection area. Therefore, the user should stay in the detection area as the water is being heated to a preset temperature, which is inconvenient.

Therefore, it is desirable to provide a water dispenser control circuit and a control method, which can overcome the limitations described above.

### BRIEF DESCRIPTION OF THE DRAWINGS

FIG. 1 is a circuit diagram of a water dispenser control circuit, according to an exemplary embodiment.

FIG. 2 is a flowchart of a water dispenser control method, according to an exemplary embodiment.

### DETAILED DESCRIPTION

Exemplary embodiments of the disclosure will now be described in detail, with reference to the accompanying drawings.

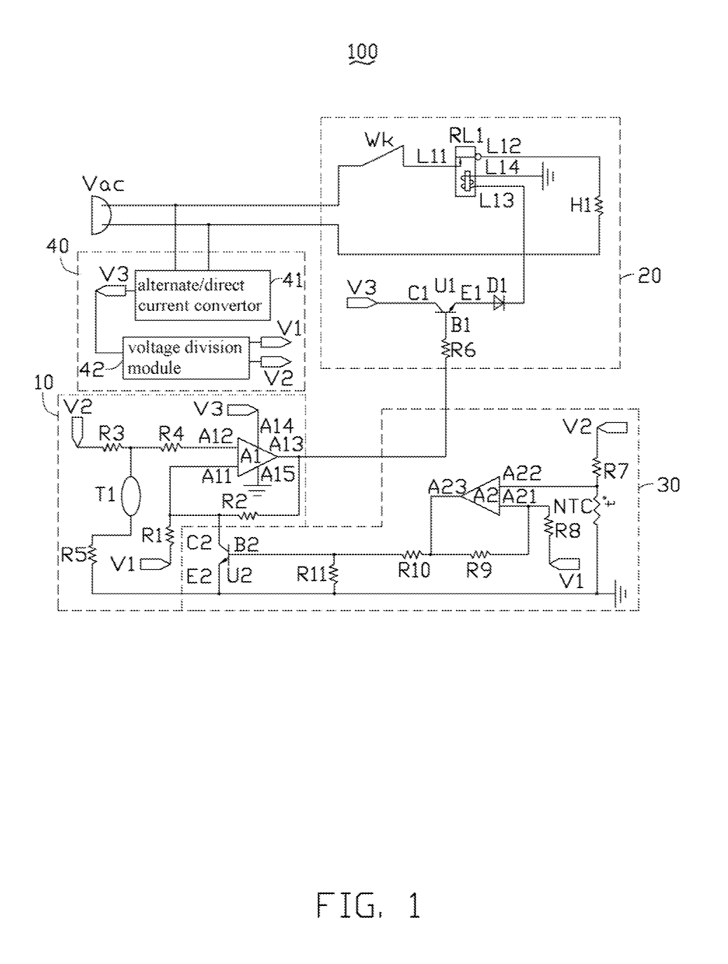

FIG. 1 is a circuit diagram of a water dispenser control circuit 100, according to an exemplary embodiment. The water dispenser control circuit 100 includes a detection circuit 10, a heating circuit 20, a water temperature sensing circuit 30, and a power circuit 40. The water dispenser control circuit 100 can be used in a water dispenser to heat water, for example.

The detection circuit 10 includes a first operational amplifier A1, a detector T1, a first resistor R1, a second resistor R2, a third resistor R3, a fourth resistor R4, and a fifth resistor R5. The first operational amplifier A1 includes a first positive input terminal A11, a first negative input terminal A12, a first output terminal A13, a power terminal A14, and a second coil terminal A15. The first positive input terminal A11 is connected to a first reference voltage V1 via the first resistor R1. The negative input terminal A12 is connected to a second reference voltage V2 via the third resistor R3. The first output terminal A13 is connected to the first positive terminal A11 via the second resistor R2. The power terminal A14 is connected to a third reference voltage V3. The second coil terminal A15 is grounded. The fourth resistor R4 and the third resistor R3 are connected in series, and the fourth resistor R4 is connected between the third resistor R3 and the first negative input terminal R12. The voltage values of the first, second, and third voltage reference voltages V1, V2, V3 and the resistances of the first and second resistors R1, R2 satisfy the formulas: (V3−V1)*R1/(R1+R2)+V1>V2, V2>V1, and V3>V1. One end of the detector T1 is connected between the third resistor R3 and the fourth resistor R4, and another end of the detector T1 is grounded via the fifth resistor R5. The detector T1 measures a detection area. When a user comes into the detection area, the detector T1 is switched on, otherwise the detector T1 is switched off.

The heating circuit 20 includes a first transistor U1, a sixth resistor R6, a diode D1, a relay RL1, an anti-dry protection element WK, and a heating element H1. The first transistor U1 is an npn type BJT, and includes a first collector C1, a first emitter E1, and a first base B1 configured for controlling the connection and disconnection of the first collector C1 and the first emitter E1. The first collector C1 is connected to the third reference voltage V3. The first emitter E1 is connected to a cathode of the diode D1. The first base B1 is connected to the first output terminal A13 via the sixth resistor R6. The relay RL1 includes a movable iron armature RL11, a contacting terminal RL12, a first coil terminal RL13, and a second coil terminal RL14. The movable iron armature RL11 is connected to a positive wire of an alternating power Vac via the anti-dry protection element WK. The contacting terminal RL12 is connected to a negative wire of the alternating power Vac via the heating element H1. When the first coil terminal RL13 is input a high level voltage, such as +5v, the movable iron armature RL11 will connect to the contacting terminal RL12. The anti-dry protection element WK will be broken when the water of the water dispenser is exhausted and the heating element H1 keeps working.

The water temperature sensing circuit 30 includes a temperature controlling resistor NTC, a second operational amplifier A2, a second transistor U2, a seventh resistor R7, an eighth resistor R8, a ninth resistor R9, a tenth resistor R10, and an eleventh resistor R11. One end of the temperature controlling resistor NTC is connected to the second reference voltage V2 via the seventh resistor R7, and other end is grounded. The second operational amplifier A2 includes a second positive input terminal A21, a second negative input terminal A22, and a second output terminal A23. The second positive input terminal A21 is connected to the first reference voltage V1. The second negative input terminal A22 is connected between the temperature controlling resistor NTC and the seventh resistor R7. The second output terminal A23 is connected to the second positive input terminal A21 via the ninth resistor R9. The second transistor U2 is an npn type BJT, and includes a second collector C2, a second emitter E2, and a second base B2 configured for controlling connection and disconnection of the second collector C2 and the second emitter E2. The second collector C2 is connected between the first resistor R1 and the second resistor R2. The second emitter E2 is grounded. The second base B2 is connected to the second output terminal A23 via the tenth resistor R10. One end of the eleventh resistor R11 is connected to the second base B2, and the other end is grounded. The temperature controlling resistor NTC is configured for sensing temperature of the water. When the temperature of the water increases, the resistance of the temperature controlling resistor NTC decreases, and when the temperature of the water decreases, the resistance of the temperature controlling resistor NTC increases. When the temperature of the water is greater than a preset temperature, the voltage value of the second negative input terminal A22 is less than the first reference voltage V1.

The power circuit 40 includes an alternate/direct current convertor 41 and a voltage division module 42 connected to the alternate/direct current convertor 41. The alternate/direct current convertor 41 is configured for converting the alternating power Vac to the third reference voltage V3 which is a direct voltage. The voltage division module 42 is configured for dividing the third reference voltage V3 to the first reference voltage V1 and the second reference voltage V2 via a number of voltage divider resistors (not shown).

When the user comes into the detection area of the detector T1, the detector T1 is switched on. The first negative input terminal A12 of the first operational amplifier A1 is grounded, and the voltage value of the first positive input terminal A11 is greater than that of the first negative input terminal A12. The first output terminal A13 outputs a high level voltage to the first base B1. The high level voltage is equal to the third reference voltage V3. The first collector C1 is connected to the first emitter E1. As the high level voltage is input to the first coil terminal RL13 of the relay RL1, the movable iron armatureRL11 is connected to the contacting terminalRL12. Therefore, the heating element H1 is connected to the alternating power Vac and starts to heat the water.

During heating, if the user stays in the detection area of the detector T1, the movable iron armatureRL11 keeps connection with the contacting terminalRL12. The heating element H1 will not stop to heat the water until the temperature of the water is greater than the preset temperature.

If the user leaves from the detection area of the detector T1 during heating, the detector T1 is cut off. The first negative input terminal A12 of the first operational amplifier A1 is connected to the second reference voltage V2. As the voltage values of the first, second, and third voltage reference voltages V1, V2, V3 and the resistances of the first and second resistors R1, R2 satisfy the formula: (V3−V1)*R1/(R1+R2)+V1>V2, the first output terminal A13 keeps outputting the high level voltage to the first transistor U1. The heating element H1 keeps heating the water.

When the water is heated to a temperature which is greater than the preset temperature, the resistance of the temperature controlling resistor NTC is decreased. The voltage value of the second negative input terminal A22 of the second operational amplifier A2 is less than the first reference voltage V1 of the second positive input terminal A21, the second output terminal A23 outputs a high level voltage to the second base B2 of the second transistor U2. The second collector C2 is connected to the second emitter E2. The first output terminal A13 and the first positive input terminal A11 are grounded. The first collector C1 is disconnected to the first emitter E1. The movable iron armature RL11 and the contacting terminal RL12 are broken. The heating element H1 stops to heat the water. As the first positive input terminal A11 is grounded, the voltage value of the first negative input terminal A12 is greater than that of the first positive input terminal A11. The first output terminal A13 keeps outputting a low level voltage to the first base B1 of the first transistor U1. When the temperature of the water is less than the preset temperature, the second output terminal A23 of the second operational amplifier A2 outputs a low level voltage to the second base B2 of the second transistor U2. As the second reference voltage V2 of the first negative input terminal A12 is greater than the first reference voltage V1 of the first positive input terminal A11. The first output terminal A14 keeps outputting the low level voltage, and the heating element H1 stops heating.

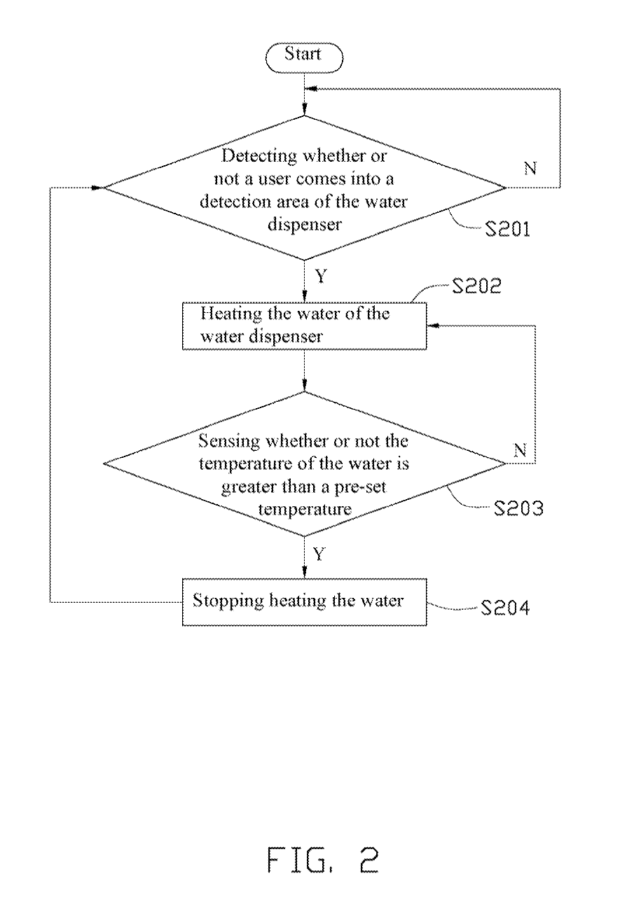

FIG. 2 shows a flowchart of an exemplary method for controlling a water dispenser to heat the water. In this embodiment, the method includes the following steps S201-S204:

In step S201, a detection circuit 10 detects whether or not a user comes into a detection area; the detection circuit 10 includes a detector T1, and the detector T1 measures the detection area;

In step S202, a heating circuit 20 heats the water of the water dispenser when the user comes into the detection area; if the user leaves from the detection area during the heating process, the water will be heated continually;

In step S203, a water temperature sensing circuit 30 senses whether or not the temperature of the water is greater than a preset temperature;

In step S204, the heating circuit 20 stops to heat the water when the temperature of the water is greater than the preset temperature; and returning to S201.

It will be understood that particular exemplary embodiments and methods are shown and described by way of illustration only. The principles and the features of the present disclosure may be employed in various and numerous exemplary embodiments thereof without departing from the scope of the disclosure as claimed. The above-described exemplary embodiments illustrate the scope of the disclosure but do not restrict the scope of the disclosure.

What is claimed is:

1. A water dispenser control circuit, comprising:
a detection circuit configured for detecting whether or not a user comes into a detection area;
a heating circuit configured for heating a water of a dispenser;
a water temperature sensing circuit configured for sensing a temperature of the water; and
a power circuit supplying power to the detection circuit, the heating circuit, and the water temperature sensing circuit;
wherein when the user comes into the detection area, the detection circuit controls the heating circuit to heat the water until the temperature of the water sensed by the water temperature sensing circuit is greater than a preset temperature.

2. The water dispenser control circuit in claim 1, wherein the detection circuit comprises a first operational amplifier, a detector, a first resistor, a second resistor, and a third resistor; the first operational amplifier comprises a first positive input terminal connected to a first reference voltage via the first resistor, a first negative input terminal connected to a second reference voltage via the third resistor, a first output terminal connected to the first positive input terminal via the second resistor, a power terminal connected to a third reference voltage, and a second coil terminal; one end of the detector is connected to the first negative input terminal, and another end of the detector is grounded.

3. The water dispenser control circuit in claim 2, wherein when the user comes into the detection area, the detector is switched on, otherwise the detector is switched off.

4. The water dispenser control circuit in claim 3, wherein the voltage values of the first, second, and third voltage reference voltages and the resistances of the first and second resistors satisfy the formulas:
(V3−V1)*R1/(R1+R2)+V1>V2,
V2>V1, and
V3>V1;
where V1 is the first reference voltage, V2 is the second reference voltage, V3 is the third reference voltage, R1 is the resistance of the first resistor, and R2 is resistance of the second resistor.

5. The water dispenser control circuit in claim 1, wherein the heating circuit comprises a first transistor, a relay, and a heating element; the first transistor comprises a first collector connected to the third reference voltage, a first emitter connected to the relay, and a first base connected to the first output terminal; the relay comprises a movable iron armature connected to a positive wire of an alternating power, a contacting terminal connected to one end of the heating element, and first coil terminal connected to the first emitter; the other end of the heating element is connected to a negative wire of the alternating power; when a high level voltage is input to the first coil terminal, the movable iron armature is connected to the fixing terminal.

6. The water dispenser control circuit in claim 5, wherein the water temperature sensing circuit comprises a temperature controlling resistor, a second operational amplifier, a second transistor, and a seventh resistor; one end of the temperature controlling resistor is connected to the second reference voltage via the seventh resistor, and another end is grounded; the second operational amplifier comprises a second positive input terminal connected to the first reference voltage, a second negative input terminal connected between the temperature controlling resistor and the seventh resistor, and a second output terminal; the second transistor comprises a second collector connected between the first resistor and the second resistor, a second emitter is grounded, and a second base connected to the second output terminal.

7. The water dispenser control circuit in claim 6, wherein the first transistor and the second transistor are npn type BJTs.

8. The water dispenser control circuit in claim 6, wherein when the temperature of the water is increased, the resistance of the temperature controlling resistor is decreased; when the temperature of the water is decreased, the resistance of the temperature controlling resistor is increased; when the temperature of the water is greater than the preset temperature, the voltage value of the second negative input terminal is less than the first reference voltage.

9. The water dispenser control circuit in claim 7, wherein the power circuit comprises an alternate/direct current convertor and a voltage division module connected to the alternate/direct current convertor; the alternate/direct current convertor is configured for converting the alternating power to the third reference voltage which is a direct voltage; the voltage division module is configured for dividing the third reference voltage to the first reference voltage and the second reference voltage.

10. A water dispenser control method, comprising:
detecting whether or not a user comes into a detection area of the water dispenser;
heating the water of the water dispenser when the user comes into the detection area;
sensing whether or not the temperature of the water is greater than a preset temperature; and
stopping heating the water when the temperature of the water is greater than the preset temperature.
